(19) United States
(12) Patent Application Publication
(10) Pub. No.: US 2019/0070719 A1
(43) Pub. Date: Mar. 7, 2019

(54) ELECTRIC HAMMER HAVING SPIRAL IMPACT DEVICE

(71) Applicant: TTI (MACAO COMMERCIAL OFFSHORE) LIMITED, Macau (MO)

(72) Inventors: Rui LIANG, Dongguan City (CN); Li Guo MA, Dongguan City (CN)

(21) Appl. No.: 16/121,981

(22) Filed: Oct. 18, 2018

(30) Foreign Application Priority Data
Sep. 7, 2017 (CN) 201710800657.X

(51) Int. Cl. B25D 11/06; B25D 16/00

(52) U.S. Cl. CPC B25D 11/068; B25D 16/00; B25D 2250/095; B25D 2250/331; B25D 2211/06

(57) ABSTRACT

An electric hammer comprising an electric motor, a spindle coupled to the electric motor and adapted to be driven by the electric motor, an impacting member adapted to be coupled to the spindle and driven by the spindle, and a direction changing device adapted to be coupled with the impacting member. The direction changing device changes the direction of movement of the impacting member such that the kinetic energy of the impacting member is provided to an energy storage device for accumulation after the change in the direction of movement. The energy storage device is adapted to return the accumulated energy to the impacting member such that the latter generates an impacting force to an output member.

### FIELD OF THE DISCLOSURE

The disclosure relates to a power tool, particularly to an electric hammer for generating an impacting force in a linear direction.

### BACKGROUND

An electric hammer as a power tool is a type of electric drills. The electric hammer in particular uses a mechanical driving force generated by the motor to generate an impacting force in a linear direction by an impacting device. Therefore, the electric hammer can be used to create holes in hard materials such as concrete, bricks, stones, etc. without the need of much effort by the user's hands. In general, electric hammers can have a variety of operating modes, such as only rotating without impacting, only impacting without rotating, or both rotating and impacting, to achieve operations with different purposes.

Most existing electric hammers convert rotational driving force generated by the motor to an impacting force in a linear direction by means of a gas-driven method or a rocking bearing method. However, both of these methods have the disadvantages of complicated structure, high failure rate, and low energy conversion efficiency.

### SUMMARY OF INVENTION

Accordingly, embodiments of the present invention provide an improved spiral hole-cutting machine that overcomes or at least alleviates the above-mentioned technical problems.

In an aspect, the invention discloses an electric hammer which contains a motor; a spindle coupled to the motor and adapted to be driven by the motor; an impacting member adapted to be coupled to and driven by the spindle; a direction changing device adapted to be coupled to the impacting member; an energy storage device coupled to the impacting member; and an output component. The direction changing device is configured to change a direction of movement of the impacting member such that kinetic energy of the impacting member is provided to the energy storage device for accumulation after the change in the direction of movement. The energy storage device is adapted to return the stored energy to the impacting member such that the latter generates an impacting force to the output member.

Preferably, the direction changing device is adapted to change the direction of movement of the impacting member following a direction of rotation of the spindle to a return direction different from the direction of rotation.

More preferably, the direction changing device contains a stopper fixed relative to the impacting member. The impacting member has a blocking member adapted to cooperate with the stopper. When the impacting member moves in the moving direction and contacts the stopper, the stopper generates a counter-acting force to the blocking member to force the impacting member to move in the returning direction.

In a specific embodiment, the stopper contains a first protruding tooth, and the blocking member is a second protruding tooth on the impacting member. The second protruding tooth is adapted to be in contact with the first protruding tooth in the moving direction.

Preferably, the stopper contains a plurality of the first protruding teeth uniformly distributed in a circumferential direction. The impacting member has a substantially cylindrical shape. A plurality of second protruding teeth with a number greater than or equal to the number of the first protruding teeth is evenly distributed on the outer surface of the cylinder.

In another specific embodiment, the impacting member is connected to the spindle by a guiding device that selectively couples the impacting member to the spindle for different period of time selectively.

Preferably, the guiding device allows the impacting member to simultaneously move in a first direction and a second direction different from the first direction.

More preferably, the first direction is parallel to a direction of rotation of the spindle and the second direction is parallel to an axis of the spindle.

According to a variation of embodiments of the present invention, the impacting member is adapted to reciprocate between the top dead center and bottom dead center in the second direction relative to the spindle. At the position of the bottom dead center, the impacting member is adapted to be coupled to the direction changing device. At the position of the top dead center, the impacting member is adapted to override the direction changing device without coupling therewith.

According to another variation of embodiments of the present invention, the impacting member has a substantially cylindrical shape. The impacting member has an impacting member spiral groove, and the spindle has a spindle spiral groove. The impacting member spiral groove and the spindle spiral groove adapted to cooperate with each other by a ball.

Preferably, the impacting member has a plurality of the impacting member spiral grooves uniformly distributed in a circumferential direction. On the spindle there are evenly distributed with the spindle spiral grooves with the same number as that of the impacting member spiral grooves.

According to another variation of embodiments of the present invention, the energy storage device is a torsion spring, a compression spring, or a gas spring.

According to another variation of embodiments of the present invention, the energy storage device is disposed within a space created by hollowing a central part of the spindle.

According to another variation of embodiments of the present invention, the spindle is connected to a motor shaft of the motor via a planetary gear device.

Another aspect of the present invention provides a method of driving an impacting member in an electric hammer to generate an impacting force. The method includes the steps of driving the impacting member to rotate in a rotational direction, changing a direction of movement of the impacting member to move in a return direction different from the direction of rotation, storing kinetic energy of the impacting member during its movement along the return direction; and releasing the stored energy such that the impacting member produces an impacting force in an impact direction different from the return direction.

Preferably, the impacting member is adapted to reciprocate between a top dead center and a bottom dead center. In the driving step, the impacting member is in the movement process from the top dead center to the bottom dead center.

In a specific embodiment, the direction of rotation and the impact direction are perpendicular to each other.

According to a variation of embodiments of the present application, in the changing step, the impacting member contacts the direction changing device to cause the moving direction of the impacting member to be changed. In the releasing step, the impacting member passes the direction changing device to generate the impacting force.

According to another variation of embodiments of the present application, the method further contains a restoration step after the releasing step. In the restoration step, the impacting member moves in a direction opposite to the impact direction to prepare to begin the driving step in a next cycle.

Accordingly, the present invention provides a number of advantages. For example, the present invention dispenses with the various complicated impacting devices used in conventional impacting tools, such as those types that use cylinders and compressed air. Compared with these conventional impacting tools, the impacting striking mechanism used in the power tool of the present invention has a simple structural design, as there is no need to consider problems such as gas sealing, pressure and the like, and also there is no need to provide a complicated control circuits. Instead, the impacting striking mechanism can fully automate the conversion from rotary motion to linear motion and simultaneously complete the energy storage step without the intervention of any control circuitry. Therefore, the power tool of the invention has lower manufacturing cost, good energy conversion efficiency, and is mainly used for providing instantaneous impacting force, which has good engineering application value.

### BRIEF DESCRIPTION OF THE DRAWINGS

The performance and advantages of the present invention will be further understood with reference to the remained part of the specification and the accompanying drawings. In some cases, a subtag is placed after a label and hyphen to represent one of many similar components. When referring to a label but does not specifically indicating a certain existing sub-tag, it refers to all of these similar components.

FIG. 1 is a schematic view of an impacting striking mechanism inside a power tool according to one embodiment of the present invention.

FIG. 2A is a front elevational view showing the spindle in the impacting striking mechanism of FIG. 1 in a state for which a planetary gear mechanism and an energy storage mechanism are not provided.

FIG. 2B shows a side view of the spindle of FIG. 2A in a state in which the planetary gear mechanism and the energy storage mechanism are arranged.

FIGS. 3A and 3B are front and side views, respectively, of the impact head of the impacting striking mechanism of FIG. 1.

FIGS. 4A and 4B are a perspective view and a top view, respectively, of the stopper of the impacting striking mechanism of FIG. 1.

FIG. 5 is a breakdown flowchart of the movement process of the impacting striking mechanism of FIG. 1 in one cycle.

FIGS. 6A-6G are schematic views of states of the impacting striking mechanism of FIG. 1 at different time points during a period of motion, respectively.

### DETAILED DESCRIPTION OF PREFERRED EMBODIMENTS

In this specification and the appended claims, the term “coupling” means that two components can be connected to each other to achieve a transfer of force, but this does not mean that the two components need to be permanently connected. Instead, the two components can be coupled to each other within a certain time and separated from each other at other times.

In addition, the direction of movement, the direction of returning, and the impact direction of the impacting member are also described in this specification and in the appended claims. It should be understood that these names are merely intended to distinguish the movement of the impacting member in different directions during one cycle, and are not intended to limit to absolute directions or orientations within a three dimensional space.

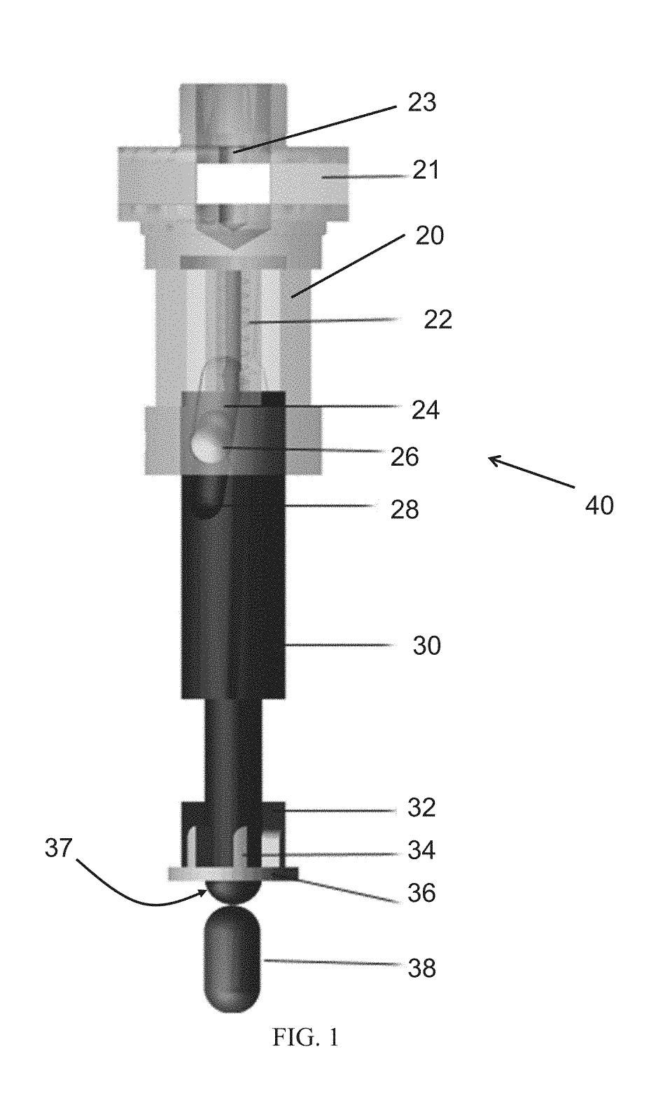

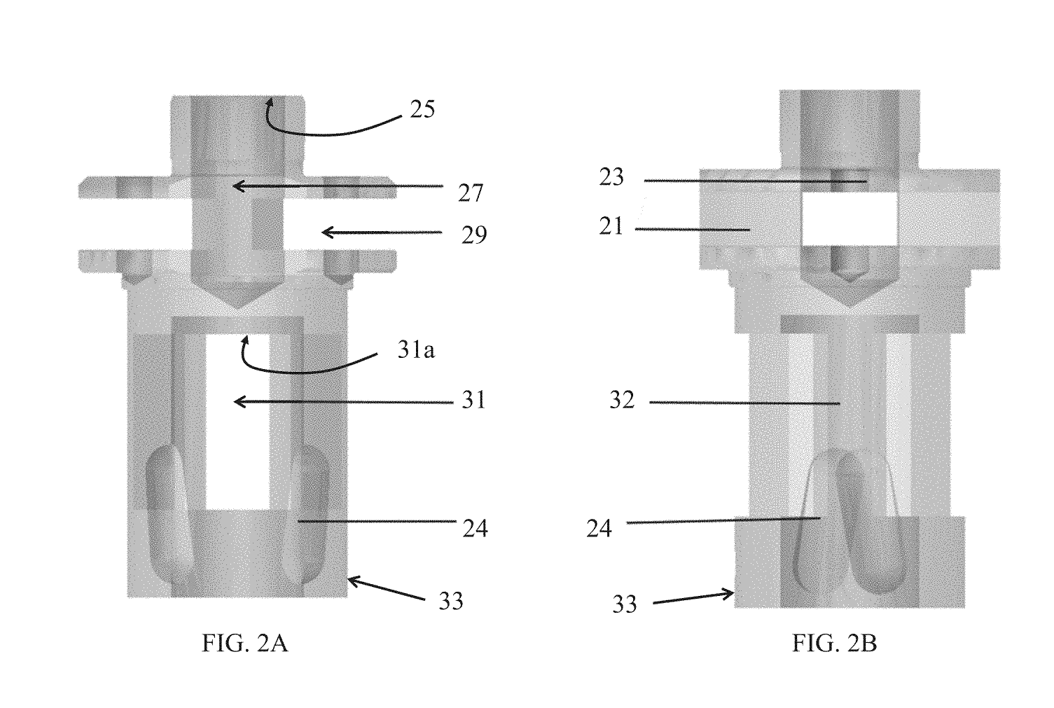

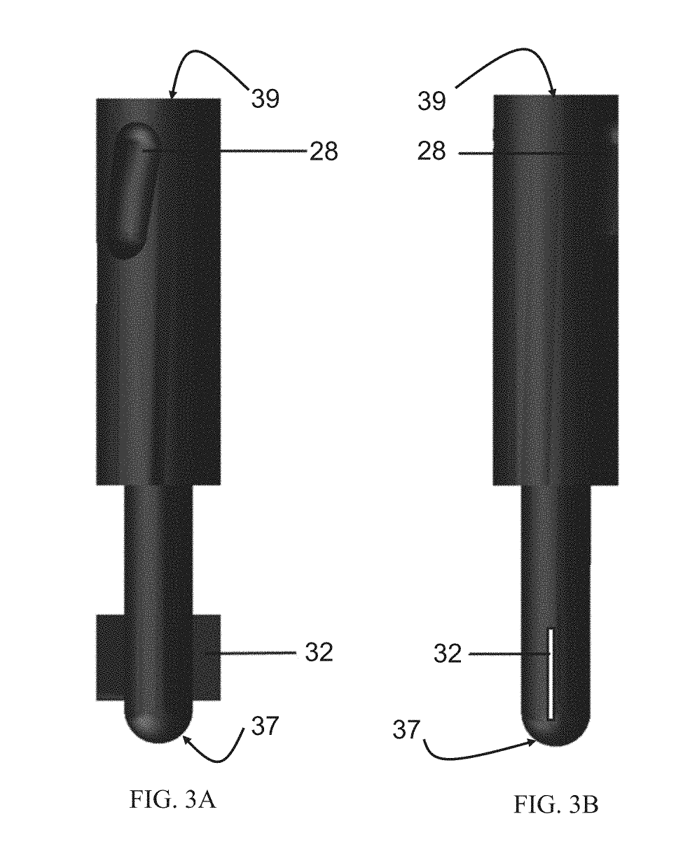

Referring first to FIG. 1, a power tool is provided according to a first embodiment of the present invention, and more particularly to an electric hammer that includes an impacting striking mechanism 40. The impacting striking mechanism 40 includes a spindle 20, and an impact head 30 coupled to and driven by the spindle 20. The impact head 30 is also referred to as an impacting member in this embodiment. The spindle 20 is connected at one end thereof via a planetary gear device 21 to an output shaft 23 of a motor (not shown) in the power tool. The other end of the spindle 20 is connected through a spindle spiral groove 24 and a ball 26 to the impact head 30, and in particular to an impact head spiral groove 28 connected to the impact head 30. Since the spindle spiral groove 24 and the impact head spiral groove 28 each have a certain length (this is more clearly shown in FIGS. 2A-2B and FIGS. 3A-3B), a relative movement of the ball 26 relative to the spindle spiral groove 24 or the impact head spiral groove 28 is possible, that is, movement of the ball 26 along the given trajectory within the groove 24. Due to the presence of the spiral groove and the ball, there is no fixed (rigid) connection between the spindle 20 and the impact head 30, but there is a certain relative motion between them. In particular, as will be described in greater detail below, the spindle 20 and the impact head 30 have a hard connection in a particular direction within certain time such that the impact head 30 can be driven by the spindle 20. While at other time, and/or in other directions, a relative movement of the impact head 30 relative to the spindle 30 occurs, as a result there is no hard connection at this time and/or in these directions.

Immediately below the impact head 30, there is an anvil 38 adapted to be contacted by and driven by an end 37 of the impact head 30. The anvil 38 serves as an output member in this embodiment. When the impact head 30 produces an impacting force, the end 37 of the impact head 30 will quickly impact from a position away from the anvil 38 onto the anvil 38, thereby giving a large impulse given to the anvil 38. This will be described in more detail later. The anvil 38 is further connected to other components of the hammer (not shown), such as a drill bit, a flat chisel, a chisel, to apply the impacting force to the final workpiece to be hammered (not shown). Other components and the like other than the impacting striking mechanism described above are well known to those skilled in the art and will not be described herein. Further, a stopper 36 is disposed at the position of the impact head 30 near the end 37. The stopper 36 is fixed to the other components of the hammer and is stationary relative to the impact head 30.

Turning now to the specific structure of the spindle 20, this is clearly shown in FIG. 1 and FIGS. 2a and 2b. The spindle 20 has a substantially cylindrical shape and is generally thin at one end and thick at one end. At the input end of the spindle 20, that is, the end at which power is received from the motor, are an opening 25 and a motor shaft space 27 communicating with the opening 25. The opening 25 is for providing access to the motor output shaft 23, while the motor shaft space 27 is for housing the motor output shaft 23 which is located at the center of the motor shaft space 27. Beside the motor shaft space 27, there is a planetary gear device space 29 for placing various components of the planetary gear device 21, such as sun gears, planet gears, racks (all not shown) and the like. The specific structure of the planetary gear device 21 is well known to those skilled in the art, and therefore will not be described herein. It is to be noted that the motor output shaft 23 is not directly connected to the spindle 20 as described above, but is connected to the spindle 20 via the planetary gear device 21, so that a rotational speed of the spindle 20 may be different from a rotational speed of the motor output shaft 23.

The spindle 20 is adjacent to its output end 33, that is, the end for outputting power to the impact head, which is relatively large in diameter with respect to an input end. Inside the thicker portion, an energy storage mechanism space is formed by a hollow part. The energy storage mechanism 32 is housed in the energy storage mechanism space 31, and the energy storage mechanism 32 may include a torsion spring, a compression spring, a gas spring, and the like. The primary function of the energy storage mechanism 32 is to store kinetic energy of the impact head 30 when the impact head 30 returns, and to provide an impacting kinetic energy to the impact head 30 during a stroke. The energy storage mechanism 32 is connected at its end to the inner end wall 31a of the energy storage mechanism space 31 and at the other end to a head end of the impact head 30 (not shown in FIGS. 2a-2b). The length of the energy storage mechanism space 31 can accommodate not only the size of the energy storage mechanism 32 in different states, but also the movement of the head end of the above-mentioned impact head 30 in the energy storage mechanism space 31.

At the same time, the spindle spiral groove 24 described above is opened on the circumferential inner surface of the spindle 20 at a position close to the output end 33 of the spindle 20 in the above-mentioned energy storage mechanism space 31. FIGS. 2a-2b show more than one spindle spiral groove 24. These spindle spiral grooves 24 are equally spaced in the circumferential direction on the inner wall in the energy storage mechanism space 31 of the spindle 20. As described above, the spindle spiral groove 24 is for accommodating the ball (not shown in FIG. 2a-2b), and the relative rotation of the impact head and the spindle 20 causes the ball to roll in the spindle spiral groove 24 in the form of rolling friction which is much smaller.

The above-mentioned opening 25, the energy storage mechanism space 31, the planetary gear device space 29, the motor shaft space, and the like all have a cylindrical inner shape. Note that several of the above-mentioned spaces are shown separately in FIG. 2a without showing the various components housed therein. Instead, the components housed therein are shown in FIG. 2b, including a motor output shaft 23, a planetary gear device 21, an energy storage mechanism 32, and the like.

Turning now to the specific construction of the impact head 30 of FIG. 1, this is clearly shown in FIG. 1 and FIGS. 3a and 3b. The impact head 30 also has a generally cylindrical shape. On the outer circumferential surface near a tip end of the impact head 30, there is opened the above-mentioned impact head spiral groove 28. The number of the impact head spiral grooves 28 is the same as the number of the above-mentioned spindle spiral grooves which is more than one in this embodiment. These impact head spiral grooves 28 are equally spaced in the circumferential direction on the circumferential outer surface near the tip end 39 of the impact head 30. As described above, the impact head spiral groove 28 is for accommodating the same ball disposed in the corresponding spindle spiral groove (not shown in FIGS. 3a-3b), and the impact head 30 and the spindle are relatively rotated causing the ball to rotate in the impact head spiral groove 28, with a friction being rolling friction, of which the friction force is much smaller.

Due to the existence of the energy storage mechanism, during the operation of the electric hammer, due to the pressure exerted by a person on the electric hammer, the rotating head will enable the steel anvil 38 and the impact head 30 to be closer, and generate a certain compression to the energy storage mechanism through the impact head. The purpose is to prevent an upper end of the impact head spiral groove 28 and a lower end of the spindle spiral groove 24 from being in close contact with the ball at the same time, which causes the groove to be damaged by the impacting. A position limiting structure is disposed outside the steel anvil 38 (not shown) cannot be moved up infinitely and cannot move down indefinitely.

At a position near the end 37 of the impact head 30, a plurality of second protruding teeth 32 are formed which act as a stopper in cooperation with a stopper as will be described in detail below. The second protruding teeth 32 have a sheet shape that protrudes perpendicularly outward from the outer circumferential surface of the impact head 30, and the surface of each of second protruding teeth 32 is perpendicular to a rotational direction of the impact head 30 at the position of the second protruding teeth 32. The plurality of second protruding teeth 32 are equidistantly disposed in the circumferential direction, and the total diameter of the two second protruding teeth 32 as shown in FIG. 3a and the impact head 30 therebetween correspond to the diameter of the impact head 30 near its tip end 37. The second protruding teeth 32 have two sides, one side being flat and one side being rounded. The flat side is used to limit the movement of the first protruding teeth 34, which will be described below, for the returning stroke of the impact head. Preferably, some needle bearings can be mounted on the second protruding teeth 32 to convert the sliding friction into rolling friction. The rounded surface of the second protruding teeth 32 is for preventing the first protruding teeth 34 and the second protruding teeth 32 from colliding with each other in the stroke state.

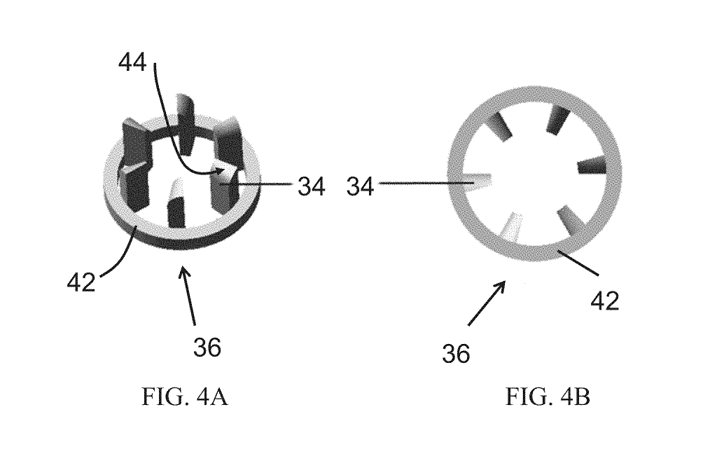

Turning now to the specific construction of the stopper 36 of FIG. 1, this is clearly shown in FIG. 1 and FIGS. 4a and 4b. The stopper 36 has a circular base 36 on which a plurality of first protruding teeth 34 are disposed. The number of first protruding teeth 34 is the same as the number of second protruding teeth on the impact head described above, so that they can correspond to each other. Three pairs of first protruding teeth 34 are shown in FIGS. 4a and 4b which are equally spaced in the circumferential direction, with each pair of first protruding teeth 34 being symmetrical about the center of the base 36. The first protruding teeth 34 has an extending direction parallel to a central axis (not shown) of the base 36, and is generally in the shape of a rectangular parallelepiped. At the distal end of the first protruding teeth 34, an acute angle 44 is formed which is inclined to one side. One side of the acute angle 44 is transitioned in a linear direction by one edge of the first protruding teeth 34, and the other side of the acute angle 44 is transitioned in an arc direction by the other opposite edge of the first protruding teeth 34. The remaining portion of an inner diameter of the base 36 after removing the width of two opposing first protruding teeth 34 is slightly larger than an outer diameter of a portion of the impact head 30 near an end as described above, so that the stopper 36 can be sleeved outside of the impact head 30, and the first protruding teeth 34 is capable to mate with second protruding teeth on the impact head.

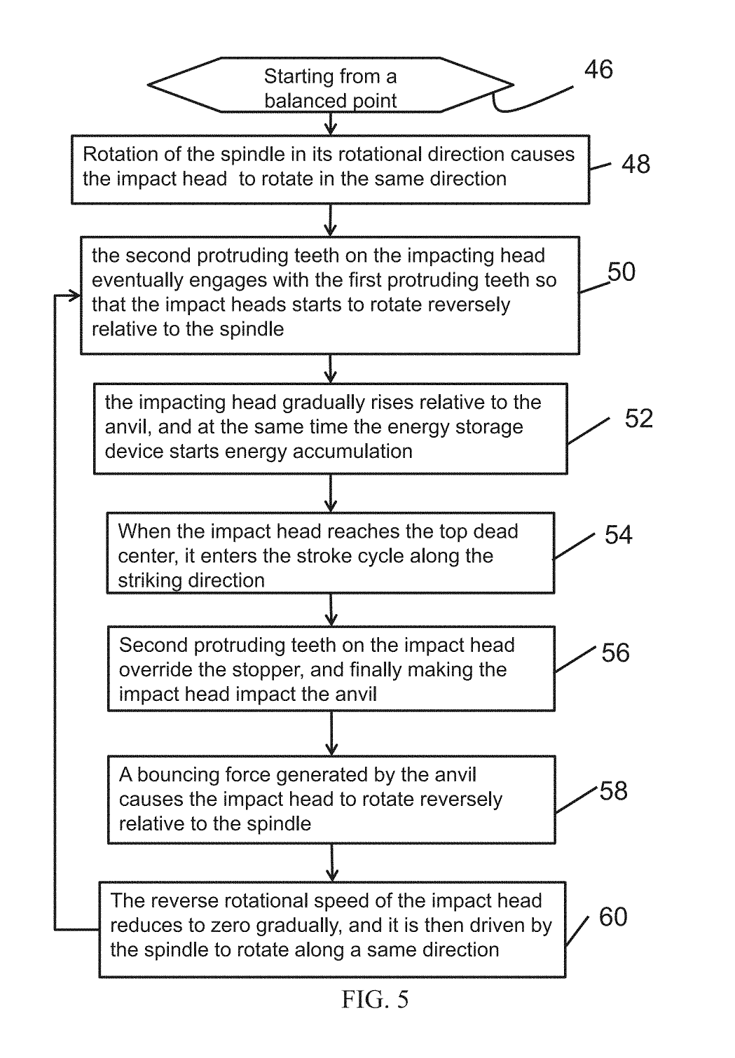

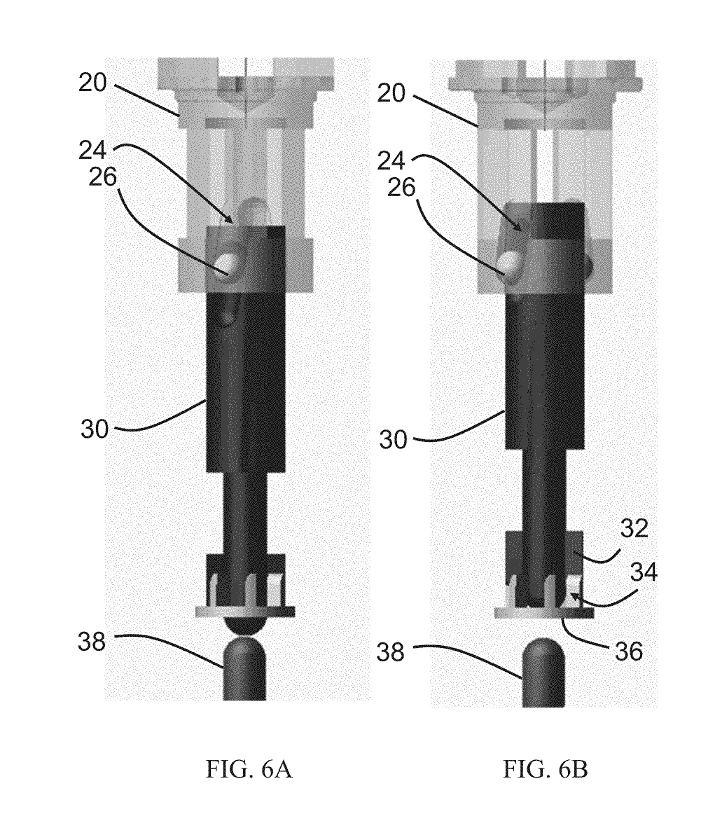

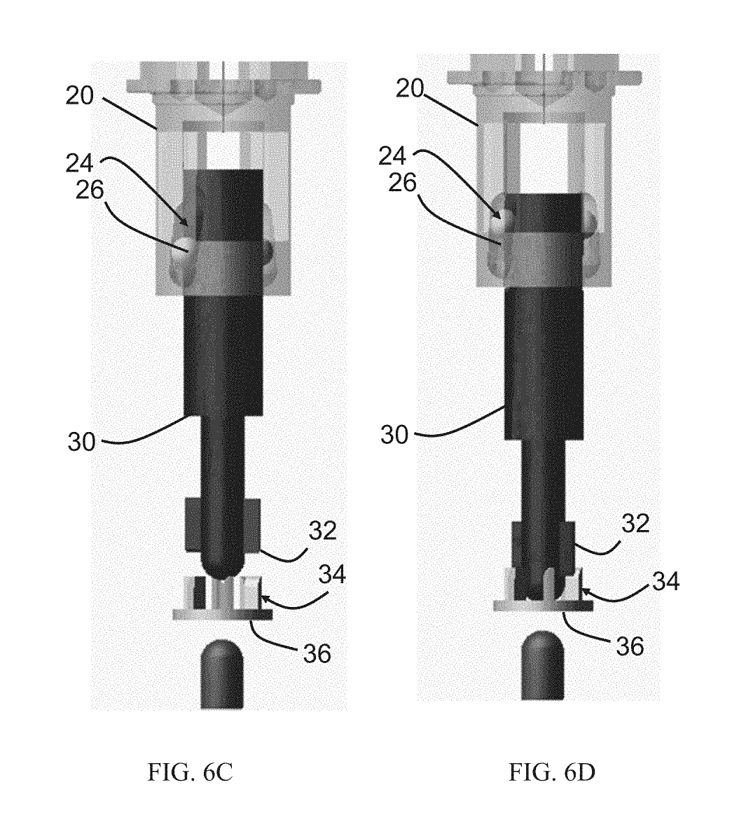

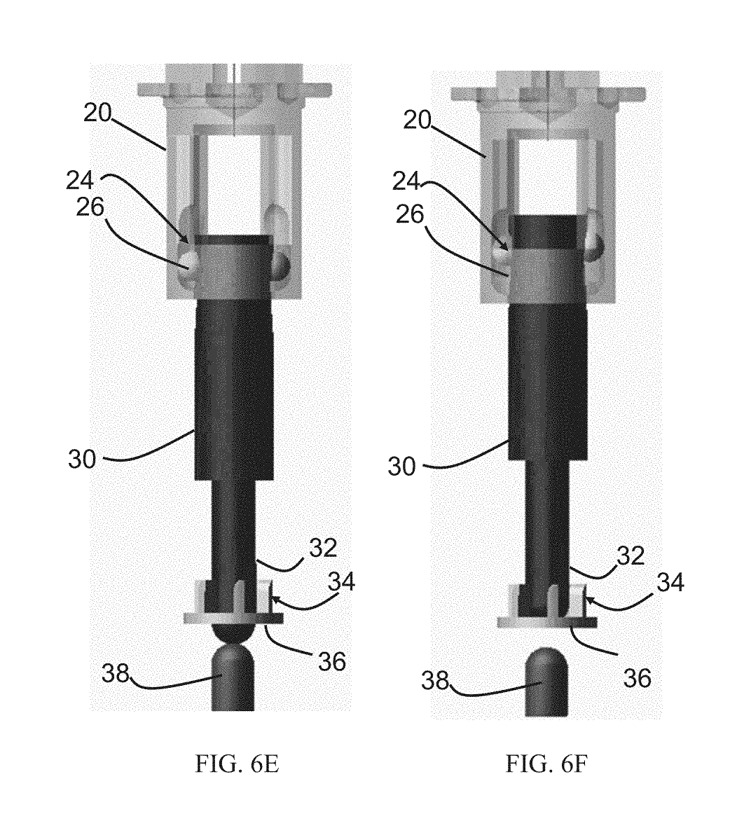

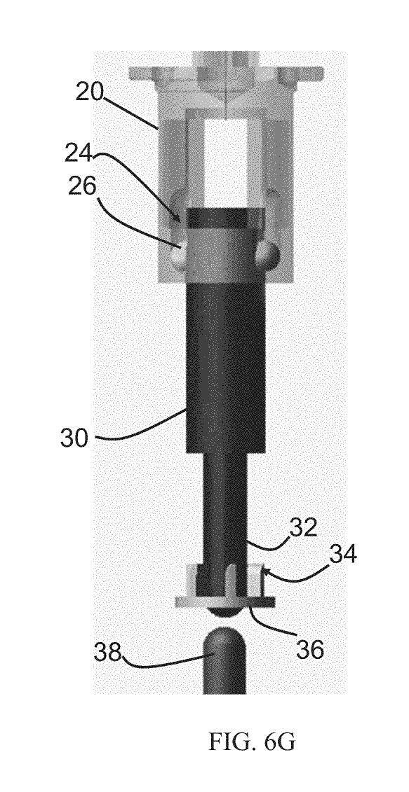

After the structure and shape of each component in the above-mentioned impacting striking mechanism are introduced, the working principle of the impacting striking mechanism 40 will now be explained with reference to FIG. 5 and FIGS. 6a-6g. When the hammer begins to operate, such as when the user presses a certain switch (not shown), the impacting striking mechanism is activated from a stationary state in Step 46 of FIG. 5. The term “stationary state” as used herein refers to a state in which the impacting striking mechanism is in a state where it is not energized which is shown in FIG. 6a. At this time, the impact head 30 is farthest from the spindle 20, and its end 37 contacts the anvil 38. The ball 26 is located at the lowermost end of the spindle spiral groove 24 on the spindle 20. At this time, the impact head 30 is at the bottom dead center position within its range of motion.

Then, as the motor of the hammer starts to rotate, an original rotational force outputted through an output shaft is converted into a rotational force of the spindle 20 having a large torque and a low speed through the above-mentioned planetary gear device. Since the ball 26 is sized to be received in the spindle spiral groove 24 or the impact head spiral groove 28, in the case of the ball 26 cannot have longitudinal displacement (i.e., the axis direction of the spindle 20) with respect to the spindle spiral groove 24 or the impact head spiral groove 28, a displacement in the lateral direction (that is, the direction of rotation of the spindle) can be generated. Therefore, the rotation of the spindle 20 in its rotational direction causes the impact head 30 to rotate in the same direction, as shown in Step 48 of FIG. 48. The above-mentioned lateral and longitudinal directions are completely different and perpendicular directions, which are also referred to as a first direction and a second direction.

During the rotation of the impact head 30 along the direction of rotation of the spindle, since the stopper 36 is stationary relative to the impact head 30, the second protruding teeth 32 on the impact head 30 will eventually contact the first protruding teeth 34 on the stopper 36 and are engaged as shown in Step 50 of FIG. 50. At this time, the first protruding teeth 34 act as a blocking member to prevent the impact head 30 from continuing to rotate following the spindle 20 in the rotational direction of the spindle 20. However, since the spindle 20 is rotated in the rotational direction all the time, the impact head 30 generates a reverse rotation with respect to the spindle 20 at this time. The reverse rotation with respect to the spindle 20, in cooperation of the ball 26 with the spindle spiral groove 24 and the impact head spiral groove 28, causes the impact head 30 to also simultaneously move upward in the longitudinal direction (i.e., in the direction approaching the spindle 20). That is, the impact head 30 is gradually raised and away from the anvil 38. The impact head 30 actually makes a helical motion relative to the spindle 20 during this process. However, during a first portion of the process in which the impact head 30 is gradually raised, the first protruding teeth 34 remains engaged with the second protruding teeth 32, as shown in FIG. 6b.

Next, as the impact head 30 is further raised, the first protruding teeth 34 will disengage from the second protruding teeth, as shown in FIG. 6c. However, at this time, the impact head 30 continues to rise, and its kinetic energy of reverse rotation gradually converts into the gravitational potential energy of the impact head 30 and the energy stored by the energy storage device (not shown), as shown in Step 52 of FIG. 5. That is to say, part of the kinetic energy of the reverse rotation of the impact head 30 becomes the gravitational potential energy, and the other part becomes the energy stored by the energy storage device.

After the above-mentioned reverse-rotation kinetic energy of the impact head 30 completely disappears, the impact head 30 simultaneously reaches the highest point, that is, the top dead center, due to the cooperation of the ball 26 with the spindle spiral groove 24 and the impact head spiral groove 28. This is shown in Step 54 of FIG. 5. At this time, the energy stored by the energy storage device is the largest, and the gravitational potential energy of the impact head 30 is also the largest. Immediately after reaching the highest point, the energy storage device begins to release its stored energy, and the impact head 30 begins to enter the stroke in the impact direction due to the gravitational potential energy and the counter-acting force generated by the energy storage device. The impact direction referred to herein is the downward direction along the axis of the impact head 30, that is, the direction from the top dead center to the bottom dead center. Due to the cooperation of the ball 26 with the spindle spiral groove 24 and the impact head spiral groove 28, the impact head 30 also simultaneously moves in the rotational direction of the spindle 20 while the impact head 30 moves in the impact direction.

During the downward movement of the impact head 30 in the impact direction, the second protruding teeth 32 is again moved toward the direction approaching the first protruding teeth 34, thus again reaching the above-mentioned disengaged position. However, since the spindle 20 is directly rotated in the rotational direction in the above several steps, the impact head 30 has also rotated by a certain angle in the rotational direction with respect to the position in FIG. 6b, at this time each of the second protruding teeth 32 has been overtaken relative to the first protruding teeth 34 that were originally engaged, so that without the restriction of the first protruding teeth 34, the impact head 30 will continue to move to the bottom dead center, which is shown in the state in FIG. 6d.

Then, as the impact head 30 finally reaches the bottom dead center position, the impact head 30 impacts the anvil 38 at a rapid rate, giving the steel anvil 38 a large impulse, creating a large momentary force on the anvil 38. This is shown in Step 56 in FIG. 5 and in FIG. 6e. Such impacting forces are further transmitted through the anvil 38 to other components in the hammer, as described above, to ultimately achieve impact on the workpiece.

While the anvil 38 generates an impacting force, the anvil 38 bounces the impact head 30, at which point the stroke ends and enters the return process, as shown in Step 58 of FIG. 5. This return process is also to reset the impact head 30. During the return process, the impact head 30 is raised upward again, and the energy given by the impact head 30 due to the rebound of the anvil 38 is gradually stored by the energy storage mechanism, so that the reverse rotation speed of the impact head 30 is gradually lowered, which is shown in the state of FIG. 6f.

The reverse rotational speed of the impact head 30 is gradually reduced to zero, and then begins to rotate as the spindle 20 begins to rotate in the direction of rotation, similar to the process described above, as shown in step 60 of FIG. 5 and the state of FIG. 6g. During the rotation of the impact head 30 along the direction of rotation of the spindle, since the stopper 36 is stationary relative to the impact head 30, the second protruding teeth 32 on the impact head 30 will eventually contact the first protruding teeth 34 on the stopper 36 and are engaged. At this point, it returns to step 50 in FIG. 5. If the motor continues to rotate at this time, the impacting striking mechanism repeats the operations of the above steps 50-60, and reciprocates between the top dead center and the bottom dead center, and continues to cycle until the power is turned off. After the power is turned off, the impacting striking mechanism will return to the state shown in FIG. 6a.

Having thus described the embodiments of the invention, it will be understood by those skilled in the art that various modifications, and other structures and equivalents may be used without departing from the spirit of the invention. Accordingly, the above description should not be considered as limiting the scope of the invention as defined by the following claims.

For example, although not shown in the above embodiment, a shaft wall of the spindle can be determined to be hollowed out depending on the design strength and the number of spiral grooves. The main role of a hollowing is to reduce the mass of the spindle and thus reduce the moment of inertia.

The helix angle of the above-mentioned spindle spiral groove and the impact head spiral groove can be set as large as possible, for example, 70 to 85°, when meeting the strength requirement of the impacting striking mechanism. The number of spiral climbing angles of the spindle spiral groove and the impact head spiral groove are the same, and the number is the same. Different numbers of spiral grooves (generally 2 to 6 pairs) can be set according to strength and life requirements.

The thickness of the first protruding teeth of the above-mentioned stopper needs to be designed according to the strength and the helix angle and the length of the spiral groove to ensure the strength requirement and the second protruding teeth on the impact head can be straddled. The number of the protruding teeth is, for example, an even number (2, 4, 6), and the number can be designed according to the helix angle of the protruding teeth and the length of the spiral groove, and it is required to ensure that the second protruding teeth of the impact head cannot contact the first protruding teeth of the stopper when the impact head is impacting, and it is also necessary to ensure that after the impact head is rebounded, and the impact can be engaged before the speed of the impact head becomes zero (it is too early to cause the circumferential impacting force to be too large, too late to cause the impact head with multiple impact phenomena).

What is claimed is:

1. An electric hammer, comprising:
a motor;
a spindle coupled to the motor and adapted to be driven by the motor;
an impacting member adapted to be coupled to and driven by the spindle;
a direction changing device adapted to be coupled to the impacting member;
an energy storage device coupled to the impacting member; and
an output component;
wherein the direction changing device is configured to change a direction of movement of the impacting member such that kinetic energy of the impacting member is provided to the energy storage device for accumulation after the change in the direction of movement; the energy storage device adapted to return the stored energy to the impacting member such that the latter generates an impacting force to the output member.

2. The electric hammer of claim 1, wherein said direction changing device is adapted to change said direction of movement of said impacting member following a direction of rotation of said spindle to a return direction different from said direction of rotation.

3. The electric hammer of claim 2, wherein said direction changing device comprises a stopper fixed relative to said impacting member; said impacting member having a blocking member adapted to cooperate with said stopper; when the impacting member moves in the moving direction and contacts the stopper, the stopper generating a counter-acting force to the blocking member to force the impacting member to move in the returning direction.

4. The electric hammer of claim 3, wherein said stopper comprises a first protruding tooth, and said blocking member is a second protruding tooth on said impacting member; said second protruding tooth adapted to be in contact with the first protruding tooth in the moving direction.

5. The electric hammer of claim 4, wherein said stopper comprises a plurality of said first protruding teeth uniformly distributed in a circumferential direction; said impacting member having a substantially cylindrical shape, a plurality of second protruding teeth with a number greater than or equal to the number of the first protruding teeth being evenly distributed on the outer surface of the cylinder.

6. The electric hammer of claim 1, wherein said impacting member is connected to said spindle by a guiding device that selectively couples said impacting member to said spindle for different period of time selectively.

7. The electric hammer of claim 6, wherein the guiding device allows the impacting member to simultaneously move in a first direction and a second direction different from the first direction.

8. The hammer of claim 7, wherein the first direction is parallel to a direction of rotation of the spindle and the second direction is parallel to an axis of the spindle.

9. The electric hammer of claim 8, wherein said impacting member is adapted to reciprocate between said top dead center and bottom dead center in said second direction relative to said spindle; at the position of the bottom dead center, the impacting member being adapted to be coupled to the direction changing device; at the position of the top dead center, the impacting member being adapted to override the direction changing device without coupling therewith.

10. The electric hammer of claim 7, wherein said impacting member has a substantially cylindrical shape; said impacting member having an impacting member spiral groove, and said spindle having a spindle spiral groove; said impacting member spiral groove and the spindle spiral groove cooperating with each other by a ball.

11. The electric hammer of claim 10, wherein said impacting member has a plurality of said impacting member spiral grooves uniformly distributed in a circumferential direction; said spindle being evenly distributed with multiple said spindle spiral grooves with the same number as that of said impacting member spiral grooves.

12. The electric hammer of claim 1, wherein the energy storage device is a torsion spring, a compression spring, or a gas spring.

13. The electric hammer of claim 1 wherein said energy storage device is disposed within a space created by a central hollowing said of said spindle.

14. The hammer of claim 1 wherein said spindle is connected to a motor shaft of said motor via a planetary gear device.

15. A method of driving an impacting member in an electric hammer to generate an impacting force, comprising the steps of:
driving the impacting member to rotate in a rotational direction;
changing a direction of movement of the impacting member to move in a return direction different from the direction of rotation;
storing kinetic energy of the impacting member during its movement along the return direction; and
releasing the stored energy such that the impacting member produces an impacting force in an impact direction different from the return direction.

16. The method of claim 15 wherein said impacting member is adapted to reciprocate between a top dead center and a bottom dead center; in said driving step, said impacting member being in the movement process from said top dead center to said bottom dead center.

17. The method of claim 16 wherein said direction of rotation and said impact direction are perpendicular to each other.

18. The method of claim 15, wherein in said changing step, said impacting member contacts the direction changing device to cause the moving direction of said impacting member to be changed; in said releasing step, said impacting member passes the direction changing device to generate the impacting force.

19. The method of claim 15, further comprising a restoration step after said releasing step, wherein in the restoration step, said impacting member moves in a direction opposite to said impact direction to prepare to begin the driving step in a next cycle.
